(19) United States
(12) Patent Application Publication
(10) Pub. No.: US 2026/0154910 A1
(43) Pub. Date: Jun. 4, 2026

(54) INTEGRATION ENABLER FOR INTEGRATING VIRTUAL WORLD AND PHYSICAL WORLD AND METHOD OF OPERATING THE SAME

(71) Applicant: Electronics and Telecommunications Research Institute, Daejeon (KR)

(72) Inventors: Changkyu LEE, Daejeon (KR); Yong-Woon KIM, Asan-si (KR); Hak Suh KIM, Daejeon (KR); Sangkeun YOO, Sejong-si (KR)

(73) Assignee: Electronics and Telecommunications Research Institute, Daejeon (KR)

(21) Appl. No.: 19/398,280

(22) Filed: Nov. 24, 2025

(30) Foreign Application Priority Data
Dec. 3, 2024 (KR) 10-2024-0177553
Oct. 24, 2025 (KR) 10-2025-0156073

(51) Int. Cl. G06T 19/00

(52) U.S. Cl. CPC G06T 19/00

(57) ABSTRACT

An integration enabler for integrating a virtual world and a physical world and a method of operating the same are provided. The method includes receiving, from a metaverse system, a first discovery request for discovering an available digital twin system, providing, in response to the first discovery request, a list of digital twin systems registered in the integration enabler to the metaverse system, receiving, from the metaverse system, a second discovery request for discovering digital twin models managed by a selected digital twin system among the list of digital twin systems, and providing, in response to the second discovery request, a list of digital twin models managed by the selected digital twin system to the metaverse system.

### CROSS-REFERENCE TO RELATED APPLICATIONS

This application claims the benefit of Korean Patent Application No. 10-2025-0156073, filed on October 24, 2025, and Korean Patent Application No. 10-2024-0177553, filed on December 3, 2024, in the Korean Intellectual Property Office, the entire disclosures of which are incorporated herein by reference for all purposes.

### BACKGROUND

### Field of the Invention

One or more embodiments relate to an integration enabler for integrating a virtual world and a physical world and a method of operating the same.

### Description of the Related Art

A digital twin is a technology for creating, on a computer, a virtual counterpart of a real-world object and simulating situations that may occur in reality through the computer to predict outcomes. The digital twin is attracting attention as a technology that may be used to solve various industrial and social problems beyond the manufacturing sector.

The digital twin is understood as an interface formed by a combination of data and information representing the structures, contexts, and operations of various physical systems, enabling understanding of past and present operating states and prediction of future conditions. The digital twin also serves as a powerful digital entity used to optimize the physical world and to improve operational performance and business processes.

The above description is information the inventor(s) acquired during the course of conceiving the present disclosure, or already possessed at the time, and is not necessarily art publicly known before the present application was filed.

### SUMMARY

Embodiments provide a method of integrating a physical world and a virtual world by using a digital twin.

Embodiments provide a method of discovering digital twin systems and digital twin models in response to a discovery request from a metaverse system and providing the discovered digital twin systems and digital twin models to the metaverse system.

Embodiments provide a method of providing a digital twin model from a digital twin system to a metaverse system in response to an access request to the digital twin model from the metaverse system.

Other objects and advantages of the present disclosure can be understood by the following description and will become more apparent by the embodiments of the present disclosure. In addition, it will be apparent that the objects and advantages of the present disclosure can be readily realized by the means and combinations thereof recited in the claims.

According to an aspect, there is provided a method of operating an integration enabler including receiving, from a metaverse system, a first discovery request for discovering an available digital twin system, providing, in response to the first discovery request, a list of digital twin systems registered in the integration enabler to the metaverse system, receiving, from the metaverse system, a second discovery request for discovering digital twin models managed by a selected digital twin system among the list of digital twin systems, and providing, in response to the second discovery request, a list of digital twin models managed by the selected digital twin system to the metaverse system.

The method may further include receiving, from the metaverse system, an access request including access information on a selected digital twin model among the list of digital twin models, requesting, in response to the access request, the selected digital twin model from a digital twin system, and transmitting, in response to receiving the selected digital twin model from the digital twin system, the selected digital twin model to the metaverse system.

The transmitting of the selected digital twin model may include determining whether a format of the selected digital twin system is different from a format of the metaverse system, and in response to determining that the formats are different, transforming the format of the selected digital twin model and transmitting the transformed digital twin model to the metaverse system.

The method may further include performing synchronization between a virtual object provided by the metaverse system and a corresponding physical object managed by the digital twin system.

The method may further include registering, in response to receiving a registration request for system information from a digital twin system, the system information, and registering, in response to receiving a registration request for metadata of a digital twin model from the digital twin system, that the metadata of the digital twin model is managed in the digital twin system.

The providing of the list of the digital twin systems to the metaverse system may include providing, in response to the first discovery request, at least one of supported model types, communication protocols, update mechanisms, an application domain, a region, a real-time function, and ownership for each of the digital twin systems to the metaverse system.

The method may further include determining a digital twin model that is no longer maintained, valid, or publicly accessible among the digital twin models managed by the selected digital twin system, and deregistering metadata of the determined digital twin model.

The method may further include determining a digital twin system that is no longer activated or no longer participating in digital twin integration with a metaverse among registered digital twin systems, and deregistering the determined digital twin system.

According to another aspect, there is provided a method of operating a metaverse system including transmitting, to an integration enabler, a first discovery request for discovering an available digital twin system, receiving, in response to the first discovery request, a list of digital twin systems registered in the integration enabler from the integration enabler, transmitting a second discovery request for discovering digital twin models managed by a selected digital twin system among the list of digital twin systems to the integration enabler, receiving, in response to the second discovery request, a list of digital twin models managed by the selected digital twin system from the integration enabler, and selecting, upon a user selection, one of the digital twin models in the list to provide a metaverse to the user.

The method may further include transmitting, to a digital twin system, a virtual model generated in the metaverse for a selected digital twin model.

The method may further include, when a digital twin is modified in the metaverse, under control of the digital twin system and in association with the integration enabler, reflecting changes in the physical world.

According to another aspect, there is provided an integration enabler including a processor and a memory storing instructions, in which the instructions, when executed by the processor, cause the integration enabler to receive, from a metaverse system, a first discovery request for discovering an available digital twin system, provide, in response to the first discovery request, a list of digital twin systems registered in the integration enabler to the metaverse system, receive, from the metaverse system, a second discovery request for discovering digital twin models managed by a selected digital twin system among the list of digital twin systems, and provide, in response to the second discovery request, a list of digital twin models managed by the selected digital twin system to the metaverse system.

The instructions, when executed by the processor, may cause the integration enabler to receive, from the metaverse system, an access request including access information on a selected digital twin model among the list of digital twin models, request, in response to the access request, the selected digital twin model from a digital twin system, and transmit, in response to receiving the selected digital twin model from the digital twin system, the selected digital twin model to the metaverse system.

The instructions, when executed by the processor, may cause the integration enabler to determine whether a format of the selected digital twin system is different from a format of the metaverse system, and in response to determining that the formats are different, transform the format of the selected digital twin model and transmit the transformed digital twin model to the metaverse system.

The instructions, when executed by the processor, may cause the integration enabler to perform synchronization between a virtual object provided by the metaverse system and a corresponding physical object managed by the digital twin system.

The instructions, when executed by the processor, may cause the integration enabler to register, in response to receiving a registration request for system information from a digital twin system, the system information, and register, in response to receiving a registration request for metadata of a digital twin model from the digital twin system, that the metadata of the digital twin model is managed in the digital twin system.

The instructions, when executed by the processor, may cause the integration enabler to provide, in response to the first discovery request, at least one of supported model types, communication protocols, update mechanisms, an application domain, a region, a real-time function, and ownership for each of the digital twin systems to the metaverse system.

The instructions, when executed by the processor, may cause the integration enabler to determine a digital twin model that is no longer maintained, valid, or publicly accessible among the digital twin models managed by the selected digital twin system, and deregister metadata of the determined digital twin model.

The instructions, when executed by the processor, may cause the integration enabler to determine a digital twin system that is no longer activated or no longer participating in digital twin integration with a metaverse among registered digital twin systems, and deregister the determined digital twin system.

Additional aspects of embodiments will be set forth in part in the description which follows and, in part, will be apparent from the description, or may be learned by practice of the disclosure.

According to embodiments, a method of integrating a physical world and a virtual world provides a more realistic metaverse to users.

According to embodiments, a method of integrating a physical world and a virtual world provides various functionalities and services to users and expands user experiences within the metaverse.

According to embodiments, a method of providing digital twin models in response to a request from a metaverse system increases interoperability between the metaverse system and a digital twin system.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating an integration enabler according to an embodiment;

FIG. 2 is a diagram illustrating functions of a metaverse system according to an embodiment;

FIG. 3 is a diagram illustrating functions of a digital twin system according to an embodiment;

FIG. 4 is a diagram illustrating functions of an integration enabler according to an embodiment;

FIG. 5 is a diagram illustrating interfaces and reference points among an integration enabler, a metaverse system, and a digital twin system according to an embodiment;

FIG. 6 is a diagram illustrating an operation flow among an integration enabler, a metaverse system, and a digital twin system according to an embodiment;

FIG. 7 is a flowchart illustrating a method of operating an integration enabler according to an embodiment;

FIG. 8 is a flowchart illustrating a method of operating a metaverse system according to an embodiment;

FIG. 9 is a block diagram illustrating an integration enabler according to an embodiment; and

FIG. 10 is a block diagram illustrating a metaverse system according to an embodiment.

### DETAILED DESCRIPTION

The following detailed structural or functional description is provided as an example only and various alterations and modifications may be made to the embodiments. Accordingly, the embodiments are not to be construed as limited to the disclosure and should be understood to include all changes, equivalents, or replacements within the idea and the technical scope of the disclosure.

As used herein, "A or B", "at least one of A and B", "at least one of A or B", "A, B or C", "at least one of A, B and C", "at least one of A, B, or C", and "one or a combination of at least two of A, B, and C," each of which may include any one of the items listed together in the corresponding one of the phrases, or all possible combinations thereof. Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is "connected", "coupled", or "joined" to another component, a third component may be "connected", "coupled", and "joined" between the first and second components, although the first component may be directly connected, coupled, or joined to the second component.

The singular forms "a", "an", and "the" are intended to include the plural forms as well, unless the context clearly indicates otherwise. It will be further understood that the terms "comprises/comprising" and/or "includes/including" when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like elements and a repeated description related thereto will be omitted.

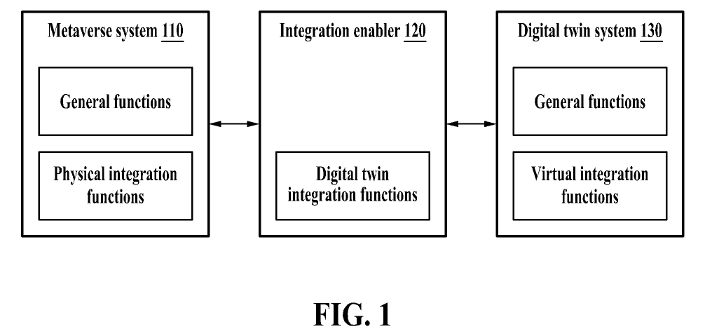

FIG. 1 is a diagram illustrating an integration enabler according to an embodiment.

Referring to FIG. 1, an integration enabler 120 integrates a metaverse system 110 and a digital twin system 130 using a digital twin to integrate a virtual world and a physical world.

A physical object refers to an object existing in the physical world. For example, a physical object may have a distinct existence in the physical world, either in a tangible form (e.g., a machine or a device) or in an intangible form (e.g., a process or a traffic flow). In the present disclosure, for convenience of description, a physical object may also be referred to as a real object or a real-world object.

A virtual object refers to a computer-generated entity designated for a virtual world. A virtual object may be a replica associated with a physical object and may serve as a digital twin.

A physical world refers to a spatial organization of a plurality of physical objects. In the present disclosure, for convenience of description, the physical world may also be referred to as the material world, the actual world, or the real world.

A virtual world refers to a spatial organization of a plurality of virtual objects. A virtual world may include global behaviors. In the virtual world, users may create avatars representing themselves and interact with virtual objects and other avatars in various ways.

A metaverse refers to a collective virtual environment in which a physical world and a virtual world are converged to allow users to interact with shared digital spaces, objects, and services. A metaverse may be virtual or augmented, may represent the real world, or may be associated with the real world. In other words, a metaverse may include virtual reality (VR), augmented reality (AR), and mixed reality (MR). The metaverse is an integrated ecosystem of virtual worlds that provide immersive experiences to users, which may modify existing concepts and create new value from economic, environmental, social, and cultural perspectives. The metaverse may include virtual worlds implemented to enable human activities corresponding to those in the real world.

A digital twin refers to a digital representation of an object of interest. For example, a digital twin may be a digital representation of physical objects in the physical world implemented in a virtual world or a metaverse. A digital twin may require different functions (e.g., synchronization or real-time support) depending on the application field. A digital twin serves as an interaction interface for linking a virtual world and a physical world, enabling users to extend their experiences beyond the limitations of a virtual environment. As a digital representation of physical objects, a digital twin may be part of a virtual world. For example, an avatar representing a user may be a digital twin in the virtual world. A digital twin may function as an interface between the two worlds to link the virtual world and the physical world. For example, a digital twin of a user may reflect facial expressions captured by user equipment through an avatar.

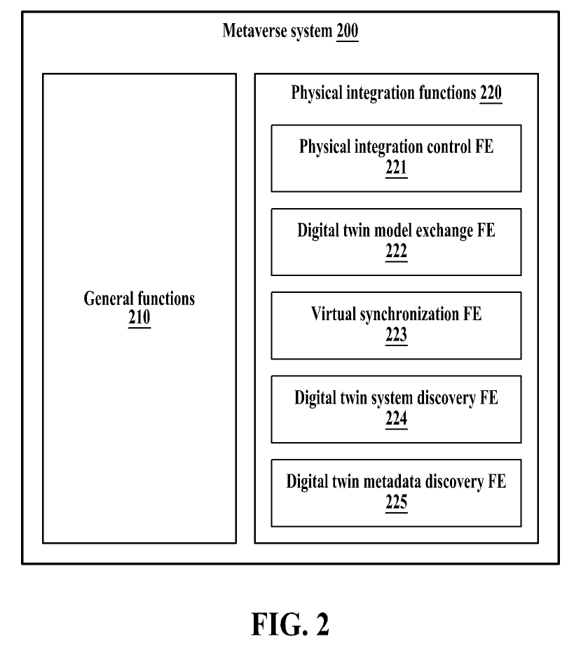

The metaverse system 110 may implement a metaverse service by designing and providing a virtual world customized according to user preferences. The metaverse system 110 may provide general functions (GFs) and physical integration functions (PIFs). The physical integration functions provided by the metaverse system 110 are described in detail below with reference to FIG. 2.

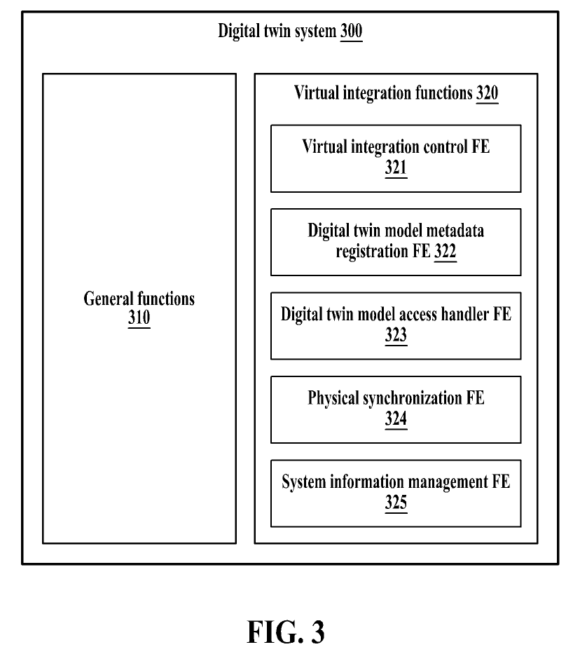

The digital twin system 130 may manage a digital representation of a physical object, referred to as a digital twin, and perform synchronization between the physical object and a corresponding digital twin. The digital twin system 130 may provide general functions and virtual integration functions (VIFs). The virtual integration functions provided by the digital twin system 130 are described in detail below with reference to FIG. 3.

The integration enabler 120 may be an independent system as illustrated in FIG. 1, but may be included in the metaverse system 110 or the digital twin system 130 in some embodiments. For example, the integration enabler 120 may be implemented as a set of functions included in the metaverse system 110 and/or the digital twin system 130. For instance, the integration enabler 120 may be implemented by a processor included in the metaverse system 110 or the digital twin system 130.

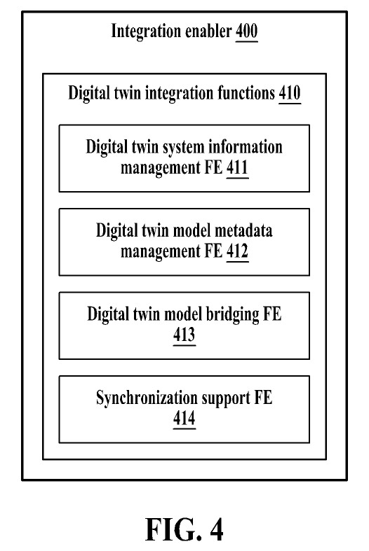

In an embodiment, the integration enabler 120 may serve as a core management framework that enables seamless integration between the metaverse system 110 and the digital twin system 130. The integration enabler 120 may provide a function for interacting with the digital twin system 130, enabling a physical object to be used as a virtual object in the metaverse. The integration enabler 120 may include various digital twin integration functions (DTIFs). The digital twin integration functions provided by the integration enabler 120 are described in detail below with reference to FIG. 4.

FIG. 2 is a diagram illustrating functions of a metaverse system according to an embodiment.

Referring to FIG. 2, a metaverse system 200 may provide general functions 210 and physical integration functions 220. The physical integration functions 220 illustrated in FIG. 2 are merely examples for description, and embodiments are not limited thereto. For example, the metaverse system 200 may be implemented such that some of the physical integration functions 220 illustrated in FIG. 2 are omitted or other functions are added.

The general functions 210 may be functions required for the metaverse system 200 to provide a standalone service. The general functions 210 may include one or more functions for integrating a digital twin, which is a virtual object, with a corresponding physical object. The physical integration functions 220 may support integration with a digital twin system.

In the present disclosure, a functional entity (FE) refers to a function that is not further divided. Operations represented by the general functions 210 and FEs 221, 222, 223, 224, and 225 illustrated in FIG. 2 may be performed by at least one component (e.g., a processor) of the metaverse system 200.

A physical integration control FE (PIC-FE) 221 may provide a function for connecting a virtual world managed by the metaverse system 200 to a physical world through integration with a digital twin system. The PIC-FE 221 may oversee the entire process of importing and exporting digital twin models, manage synchronization flows, and interact with the general functions 210 of the metaverse system 200 to perform core coordination responsibilities.

A digital twin model exchange FE (DTME-FE) 222 may provide a function for importing digital twin models from digital twin systems to a metaverse environment and exporting virtual models generated in the metaverse back to digital twin systems. The DTME-FE 222 may serve as an interface for model exchange and may be controlled by the PIC-FE 221.

A virtual synchronization FE (VS-FE) 223 may provide a function for initiating and managing synchronization between virtual objects in the metaverse and corresponding physical entities. When a user modifies a digital twin in a virtual world, the VS-FE 223 may coordinate with an integration enabler to reflect the changes in the physical world under the control of digital twin systems. The VS-FE 223 may also provide a function for reflecting changes in the physical world back to a virtual environment. The VS-FE 223 may be controlled by the PIC-FE 221.

A digital twin system discovery FE (DTSD-FE) 224 may provide a function for discovering and displaying a list of available digital twin systems registered in the integration enabler. The metaverse system 200 may identify and select an appropriate digital twin system before discovering digital twin model metadata. The DTSD-FE 224 may operate under the control of the PIC-FE 221.

A digital twin metadata discovery FE (DTMD-FE) 225 may provide a function for discovering metadata about available digital twin models managed by digital twin systems. Metadata obtained through the integration enabler may be used to provide a catalog for selecting and configuring digital twins in a virtual world. The DTMD-FE 225 may operate under the control of the PIC-FE 221.

FIG. 3 is a diagram illustrating functions of a digital twin system according to an embodiment.

Referring to FIG. 3, a digital twin system 300 may provide general functions 310 and virtual integration functions 320. The virtual integration functions 320 illustrated in FIG. 3 are merely examples for description, and embodiments are not limited thereto. For example, the digital twin system 300 may be implemented such that some of the virtual integration functions 320 illustrated in FIG. 3 are omitted or other functions are added.

The general functions 310 may be functions required for the digital twin system 300 to provide a standalone service. The general functions 310 may include one or more functions for integrating a physical object with a corresponding digital twin. The virtual integration functions 320 may support integration with a metaverse system.

Operations represented by the general functions 310 and FEs 321, 322, 323, 324, and 325 illustrated in FIG. 3 may be performed by at least one component (e.g., a processor) of the digital twin system 300.

A virtual integration control FE (VIC-FE) 321 may provide a function for controlling overall interaction flows between the digital twin system 300 and the metaverse system through an integration enabler. For example, the VIC-FE 321 may coordinate tasks such as digital twin model exchange, metadata management, and synchronization support. The VIC-FE 321 may also interact with the general functions 310 of the digital twin system 300 to support core decision-making and control.

A digital twin model metadata registration FE (DTMMR-FE) 322 may provide a function for registering metadata of digital twin models managed by the digital twin system 300. The DTMMR-FE 322 may operate under the control of the VIC-FE 321, and the VIC-FE 321 may determine metadata to be shared with the integration enabler for cataloging and discovery in the metaverse system.

A digital twin model access handler FE (DTMAH-FE) 323 may provide a function for processing import and export requests for digital twin models. The DTMAH-FE 323 may process requests received from the integration enabler after authentication and may delegate model upload or discovery tasks to the VIC-FE 321, which interacts with the general functions 310.

A physical synchronization FE (PS-FE) 324 may provide a function for performing synchronization between virtual objects (e.g., digital twin models) and corresponding physical objects. When a synchronization request is received through the integration enabler, the PS-FE 324 may transmit the received synchronization request to internal control logic such that changes in either a virtual domain or a physical domain are appropriately transmitted.

A system information management FE (SIM-FE) 325 may provide a function for registering system-level metadata (e.g., provider name or network address) of the digital twin system 300. The SIM-FE 325 may retrieve corresponding information from the general functions 310 and transmit the retrieved information to the integration enabler for registration such that the metaverse system 200 may identify and access the information.

FIG. 4 is a diagram illustrating functions of an integration enabler according to an embodiment.

Referring to FIG. 4, an integration enabler 400 may provide digital twin integration functions 410. The digital twin integration functions 410 illustrated in FIG. 4 are merely examples for description, and embodiments are not limited thereto. For example, the integration enabler 400 may be implemented such that some of the digital twin integration functions 410 illustrated in FIG. 4 are omitted or other functions are added.

The digital twin integration functions 410 may support integration between a metaverse system and a digital twin system.

Operations represented by FEs 411, 412, 413, and 414 illustrated in FIG. 4 may be performed by at least one component (e.g., a processor) of the integration enabler 400.

A digital twin system information management FE (DTSIM-FE) 411 may provide a function for registering and managing metadata (e.g., provider name, system identification (ID), and access endpoint) associated with digital twin systems. The corresponding information may be used to identify and connect digital twin systems on behalf of the metaverse system, enabling system-level integration and discovery.

A digital twin model metadata management FE (DTMMM-FE) 412 may provide a function for storing, managing, and transmitting metadata about digital twin models registered by digital twin systems. The metadata may support discovery by the metaverse system and assist users in selecting appropriate digital twins to be used in the metaverse.

A digital twin model bridging FE (DTMB-FE) 413 may provide a function for importing and exporting digital twin models between the metaverse system and digital twin systems. The DTMB-FE 413 may serve as a primary interface for model exchange and may invoke other FEs to perform tasks such as authentication, format adaptation, and access control.

A synchronization support FE (SS-FE) 414 may provide a function for managing synchronization requests between virtual objects in the metaverse and corresponding physical objects managed by digital twin systems. The SS-FE 414 may receive synchronization triggers from the metaverse and route the synchronization triggers to appropriate digital twin systems through a PS-FE. In this case, synchronization targets may include states, positions, operations, and other attributes of objects.

For example, a VS-FE of the metaverse system may control a virtual object when changes in a virtual object are to be reflected in a physical object, or vice versa. In addition, a PS-FE of a digital twin system may control a physical object when changes in the physical object are to be reflected in a virtual object, or vice versa. When changes in a virtual object are to be reflected in a physical object or changes in a physical object are to be reflected in a virtual object, the SS-FE 414 may support synchronization by connecting the VS-FE and the PS-FE and may manage a history of synchronization requests.

In an embodiment, when an operation performed in the metaverse is to be reflected in the real world, the operation may be performed in the sequence of a general function of the metaverse, a VS-FE, an SS-FE, a PS-FE, and a general function of a digital twin system. In addition, when an operation performed in the real world is to be reflected in the metaverse, the operation may be performed in the sequence of a general function of a digital twin system, a PS-FE, an SS-FE, a VS-FE, and a general function of the metaverse.

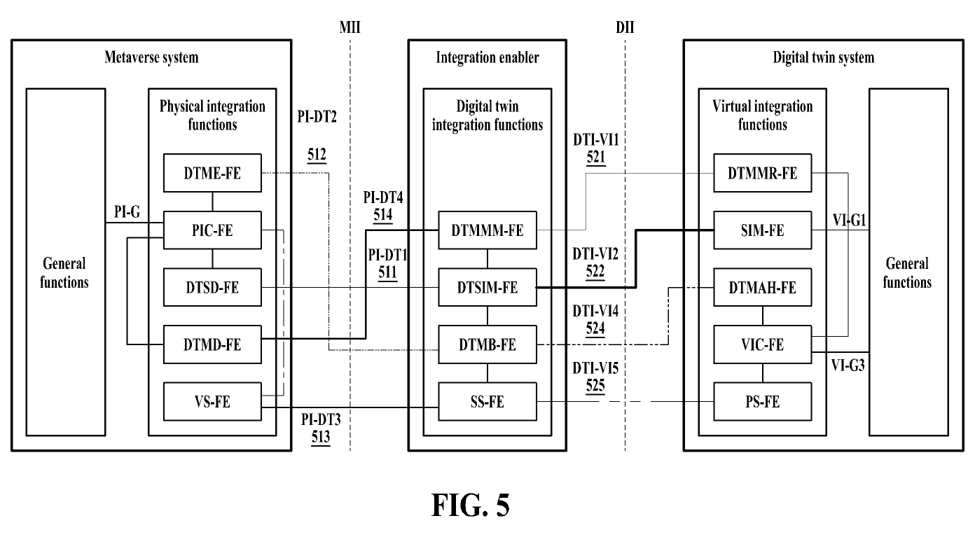

FIG. 5 is a diagram illustrating interfaces and reference points among an integration enabler, a metaverse system, and a digital twin system according to an embodiment.

Referring to FIG. 5, a metaverse integration interface (MII) between the integration enabler and the metaverse system and a digital twin integration interface (DII) between the integration enabler and the digital twin system are illustrated as examples. The metaverse integration interface and the digital twin integration interface may include various reference points that support operations among associated functional entities.

The metaverse integration interface may enable interaction between the integration enabler and the metaverse system. The metaverse integration interface may also be used to perform the following operations:

discovering available digital twin systems;

discovering metadata of available digital twin models;

exchanging data required for the use and registration of digital twins; and

exchanging synchronization-related data between digital twins and corresponding physical objects.

The digital twin integration interface may enable interaction between the integration enabler and the digital twin system. The digital twin integration interface may also be used to perform the following operations:

registering digital twin system information;

registering digital twin model metadata;

exchanging data required for the use and registration of digital twins; and

exchanging synchronization-related data between digital twins and corresponding physical objects.

A physical integration-digital twin integration 1 (PI-DTI1) 511 represents a reference point between a DTSD-FE of the metaverse system and a DTSIM-FE of the integration enabler. The PI-DTI1 511 may be used to support the discovery of digital twin systems that manage digital twin models for use in metaverse applications.

The metaverse system may use the PI-DTI1 511 to discover information about digital twin systems registered through associated functional entities. For example, a discovery process may include filtering based on system types, functions, supported domains, or operating states.

The PI-DTI1 511 may support the following operations:

retrieving a list of available digital twin systems associated with a specific service of the metaverse or domain requirements;

querying attributes (e.g., supported model types, communication protocols, update mechanisms, application domains, regions, real-time functions, or ownership) of each digital twin system; and

retrieving system-level metadata such as system IDs, registration timestamps, or operating organizations.

In an embodiment, in response to a discovery request from the metaverse system, the integration enabler may provide, to the metaverse system, at least one of supported model types, communication protocols, update mechanisms, application domains, regions, real-time functions, and ownership for each digital twin system.

A PI-DTI2 512 represents a reference point between a DTME-FE of the metaverse system and a DTMB-FE of the integration enabler. The PI-DTI2512 may be used to support the import and export of digital twin models between the metaverse system and the digital twin system.

The metaverse system may use the PI-DTI2 to import digital twin models from the digital twin system for use in the metaverse, or to export digital twin models generated by a user in the metaverse to the digital twin system. Model exchange may include full model structures, partial components, or modifications adjusted based on specific usage contexts.

The PI-DTI2 512 may support the following operations:

exporting digital twin models generated or modified by a user from the metaverse system to the digital twin system;

importing digital twin models from the digital twin system to the metaverse system for visualization, simulation, or interaction;

supporting negotiation of model formats (e.g., CAD, JSON-LD, FMI, or RDF-based models) to ensure syntactic and semantic compatibility; and

exchanging partial models or delta updates when full model transmission is unnecessary or inefficient.

A PI-DTI3 513 represents a reference point between a VS-FE of the metaverse system and an SS-FE of the integration enabler. The PI-DTI3 513 may be used to support synchronization between digital twin models in the metaverse and corresponding physical objects.

The metaverse system may use the PI-DTI3 513 to receive real-time or near-real-time data from physical objects to update corresponding digital twin models and, if necessary, to transmit state or control data from the digital twin models to the physical objects. The synchronization process may involve unidirectional or bidirectional data flows depending on application scenarios.

The PI-DTI3 513 may support the following operations:

receiving real-world data (e.g., sensor readings or event states) from physical objects to update the states of corresponding digital twin models; and

transmitting virtual state changes or control instructions from digital twin models to corresponding physical objects when permitted by the system configuration.

A PI-DTI4 514 represents a reference point between a DTMD-FE of the metaverse system and a DTMMM-FE of the integration enabler. The PI-DTI4 514 may be used to support the discovery of information about digital twin models managed by a digital twin system selected by a user.

The metaverse system may use the PI-DTI4 514 to request and receive metadata associated with available digital twin models in the selected digital twin system. The metadata may include descriptive attributes that help a user understand the purpose, structure, domain relevance, and potential for integration of the models in the metaverse.

The PI-DTI4 514 may support the following operations:

retrieving digital twin model metadata including model names, types, structures, versions, and associated application domains;

retrieving access control metadata (e.g., visibility levels, required permissions) to support secure selection or integration; and

supporting browsing or page-by-page navigation of model metadata when a large number of models are associated with the selected digital twin system.

Referring to FIG. 5, a PI-G represents a reference point between a PIC-FE of the metaverse system and the general functions of the metaverse system.

A digital twin integration-virtual integration 1 (DTI-VI1) 521 represents a reference point between a DTMMR-FE of the digital twin system and a DTMMM-FE of the integration enabler. The DTI-VI1 521 may be used to support the registration of information about digital twin models managed by the digital twin system.

Through the DTI-VI1 521, the digital twin system may submit metadata describing the characteristics and usage contexts of corresponding models. The metadata may enable associated functional entities to allow metaverse systems to discover and use the models through appropriate discovery and selection mechanisms.

The DTI-VI1 521 may support the following operations:

submitting digital twin model metadata including model ID, name, version, structural type, applicable domains, and supported functions;

updating or modifying existing model metadata to reflect changes such as version upgrades, updated descriptions, or compatibility details; and

deregistering digital twin model metadata that is no longer maintained, valid, or publicly accessible.

A DTI-VI2 522 represents a reference point between a SIM-FE of the digital twin system and a DTSIM-FE of the integration enabler. The DTI-VI2 522 may be used to support the registration of information about digital twin systems that manage digital twin models for potential use in the metaverse.

Through the DTI-VI2 522, the digital twin system may provide system-level metadata and operational descriptors that describe the system's identity, capabilities, and supported application domains. The DTI-VI2 522 may enable associated functions to facilitate discovery and use of the system in scenarios where digital twin models are accessed or exchanged with the metaverse.

The DTI-VI2 522 may support the following operations:

- submitting digital twin system information, including system name, system ID, provider organization, supported application domains, and communication interfaces;

retrieving usage-related data, such as model availability status, creation and update timestamps, and historical usage context;

updating or modifying previously registered system information to reflect changes in capability, operational status, or technical configuration; and

deregistering digital twin systems that are no longer active or no longer participating in digital twin integration with the metaverse.

A DTI-VI4 524 represents a reference point between a DTMAH-FE of the digital twin system and a DTMB-FE of the integration enabler. The DTI-VI4524 may be used to support the import and export of digital twin models between the metaverse system and the digital twin system.

Through the DTI-VI4 524, digital twin models may be imported from the metaverse system to the digital twin system (e.g., user-generated models) or exported from the digital twin system for use in the metaverse. Associated functions may handle model transformation, compatibility, and validation to ensure consistency across system environments.

The DTI-VI4 524 may support the following operations:

importing digital twin models into the digital twin system, where models may be transmitted from the DTMB-FE to the DTMAH-FE based on user uploads or selections in the metaverse; and

exporting digital twin models from the digital twin system, where models may be transmitted from the DTMAH-FE to the DTMB-FE for transmission to the metaverse system.

A DTI-VI5 525 represents a reference point between a PS-FE of the digital twin system and an SS-FE of the integration enabler. The DTI-VI5 525 may be used to support synchronization between digital twin models in the metaverse and corresponding physical objects managed by the digital twin system.

Through the DTI-VI5 525, data flows associated with sensing, control, and state updates may be exchanged to ensure consistency between the physical state of real-world objects and their digital representations in the metaverse. The synchronization process may include real-time or periodic updates, directionality control, and time-sensitive data processing.

The DTI-VI5 525 may support the following operations:

transmitting physical object state data from the PS-FE to the SS-FE to update corresponding digital twins in the metaverse; and

receiving control instructions or state requests by the PS-FE from the SS-FE to affect or monitor physical object operation based on virtual interactions.

Referring to FIG. 5, a VI-G1 represents a reference point between a SIM-FE of the digital twin system and the general functions of the digital twin system. A VI-G3 represents a reference point between a VIC-FE of the digital twin system and the general functions of the digital twin system.

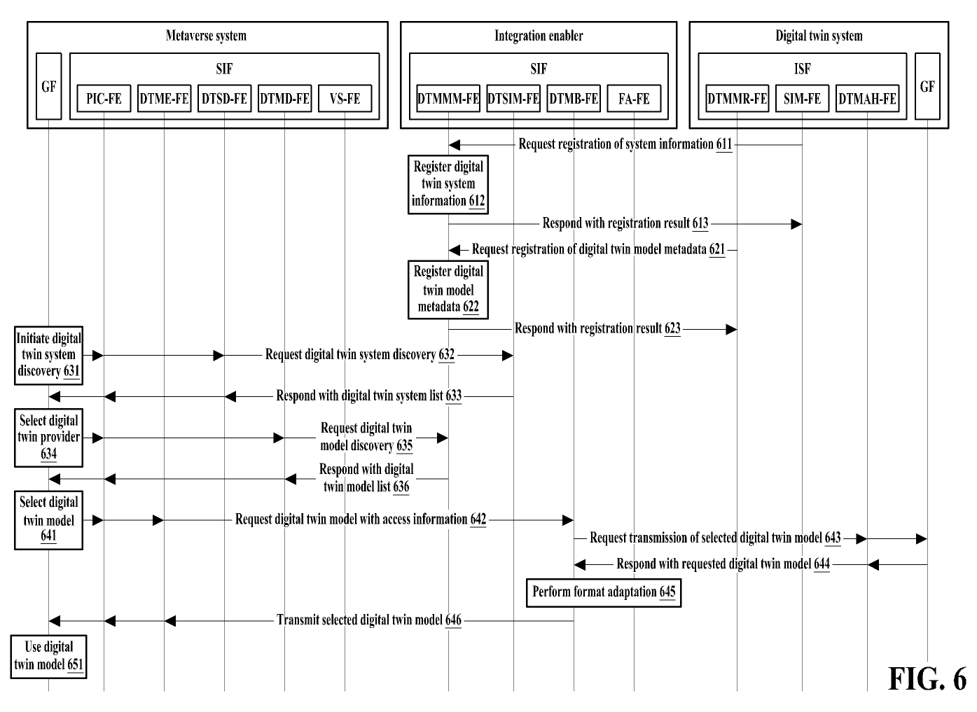

FIG. 6 is a diagram illustrating an operation flow among an integration enabler, a metaverse system, and a digital twin system according to an embodiment.

Referring to FIG. 6, an operation flow in which a digital twin is integrated into a metaverse system through an integration enabler is illustrated as an example. For convenience of description, FIG. 6 illustrates each operation as being performed by corresponding FEs. However, in some embodiments, the operations may be performed by devices or systems (e.g., a metaverse system, an integration enabler, or a digital twin system) including the corresponding FEs.

In the following embodiments, operations may be performed sequentially but need not necessarily be performed sequentially. For example, the order of the operations may be changed and at least two of the operations may be performed in parallel. Operations 611 through 651 may be performed by at least one component (e.g., a processor) of the metaverse system, the integration enabler, or the digital twin system.

In operation 611, the digital twin system may transmit a registration request for system information for the digital twin system to a DTSIM-FE of the integration enabler through a SIM-FE.

In operation 612, the DTSIM-FE of the integration enabler may register and store the received system information. In an embodiment, in response to receiving a registration request from the digital twin system, the DTSIM-FE of the integration enabler may register the system information.

In operation 613, the DTSIM-FE of the integration enabler may return a response to the SIM-FE of the digital twin system with the registration result of the system information.

In operation 621, the digital twin system may transmit a registration request for metadata of a digital twin model to a DTMMM-FE through a DTMMR-FE.

In operation 622, the DTMMM-FE of the integration enabler may register the received digital twin metadata as being managed by the digital twin system that requested the registration. In an embodiment, in response to receiving a registration request for metadata of a digital twin model from the digital twin system, the DTMMM-FE of the integration enabler may register the digital twin metadata as being managed by the digital twin system.

In operation 623, the DTMMM-FE of the integration enabler may return a response to the DTMMR-FE of the digital twin system with the registration result of the metadata.

In operation 631, the metaverse system may initiate a discovery process to discover available digital twin systems. Operation 631 may correspond to a user operation to discover potential digital twin providers (e.g., digital twin systems).

In operation 632, a DTSD-FE of the metaverse system may transmit a discovery request for discovering available digital twin systems to the DTSIM-FE of the integration enabler.

In operation 633, the DTSIM-FE of the integration enabler may return a response to the metaverse system with a list of registered digital twin systems.

In operation 634, the metaverse system may select one of the available digital twin providers from the list. Operation 634 may correspond to a user selection.

In operation 635, the metaverse system may transmit a discovery request for discovering digital twin models managed by the selected digital twin system to the DTMMM-FE of the integration enabler through a DTMD-FE.

In operation 636, the DTMMM-FE of the integration enabler may transmit a response with a list of registered digital twin models.

In operation 641, the metaverse system may select a specific digital twin model from the list. Operation 641 may correspond to a user selection based on the discovery result.

In operation 642, the metaverse system may transmit an access request including access information to a DTMB-FE of the integration enabler through the DTME-FE.

In operation 643, the DTMB-FE of the integration enabler may transmit a request to retrieve the selected digital twin model to a DTMAH-FE of the digital twin system.

In operation 644, the digital twin system may return the requested digital twin model to the DTMB-FE of the integration enabler through the DTMAH-FE.

In operation 645, the DTMB-FE of the integration enabler may optionally perform format adaptation if necessary.

In operation 646, the digital twin model may be transmitted from the DTMB-FE of the integration enabler to the DTME-FE of the metaverse system.

In operation 651, the metaverse system may use the retrieved digital twin model to enable user interaction or to provide associated services in the metaverse.

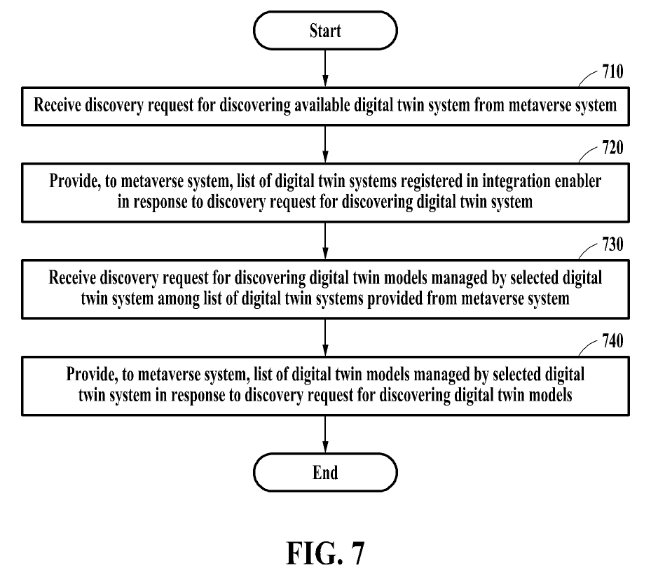

FIG. 7 is a flowchart illustrating a method of operating an integration enabler according to an embodiment.

In the following embodiments, operations may be performed sequentially but need not necessarily be performed sequentially. For example, the order of the operations may be changed and at least two of the operations may be performed in parallel. Operations 710 through 740 may be performed by at least one component (e.g., a processor) of the integration enabler.

In operation 710, the integration enabler may receive a first discovery request for available digital twin systems from the metaverse system.

In operation 720, the integration enabler may provide, to the metaverse system, a list of digital twin systems registered in the integration enabler in response to the first discovery request. The integration enabler may provide, to the metaverse system, at least one of supported model types, communication protocols, update mechanisms, application domains, regions, real-time functions, and ownership for each digital twin system in response to the first discovery request.

In operation 730, the integration enabler may receive a second discovery request for digital twin models managed by a selected digital twin system among the list of digital twin systems provided from the metaverse system.

In operation 740, the integration enabler may provide, to the metaverse system, a list of digital twin models managed by the selected digital twin system in response to the second discovery request.

The integration enabler may receive an access request including access information about a selected digital twin model among a list of digital twin models from the metaverse system. Upon the access request, the integration enabler may request the selected digital twin model from the digital twin system. In response to receiving the selected digital twin model from the digital twin system, the integration enabler may transmit the selected digital twin model to the metaverse system. The integration enabler may determine whether the selected digital twin system and the metaverse system have different formats, and in response to determining that they have different formats, may transform the format of the selected digital twin model before transmitting it to the metaverse system. The integration enabler may perform synchronization between a virtual object of the metaverse provided by the metaverse system and a corresponding physical object managed by the digital twin system. In response to receiving a registration request for system information from the digital twin system, the integration enabler may register the system information. In response to receiving a registration request for metadata of a digital twin model from the digital twin system, the integration enabler may register that the metadata of the digital twin is managed in the digital twin system. The integration enabler may determine a digital twin model that is no longer maintained, valid, or publicly accessible among digital twin models managed by the selected digital twin system and may deregister the metadata of the determined digital twin model. The integration enabler may determine a digital twin system that is no longer active or no longer participating in digital twin integration with the metaverse among registered digital twin systems and may deregister the determined digital twin system.

The descriptions provided above with reference to FIGS. 1 through 6 are also applicable to the operations illustrated in FIG. 7, and detailed description thereof will be omitted.

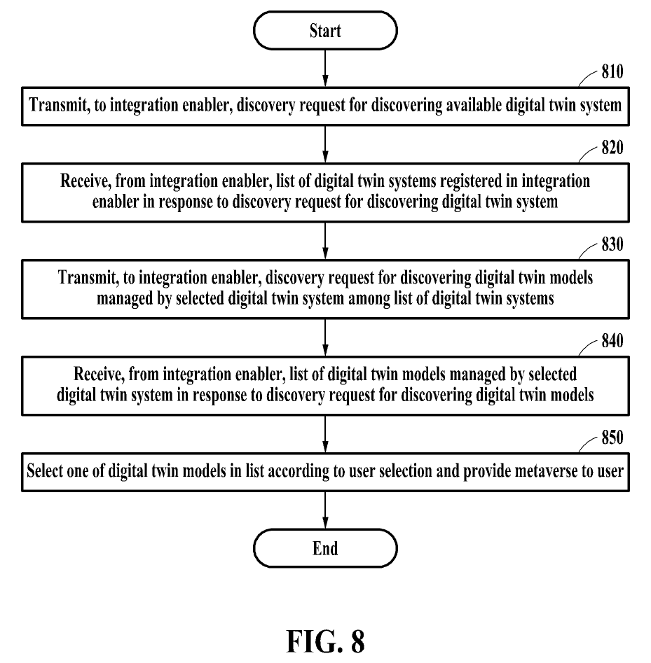

FIG. 8 is a flowchart illustrating a method of operating a metaverse system according to an embodiment.

In the following embodiments, operations may be performed sequentially but need not necessarily be performed sequentially. For example, the order of the operations may be changed and at least two of the operations may be performed in parallel. Operations 810 through 850 may be performed by at least one component (e.g., a processor) of the metaverse system.

In operation 810, the metaverse system may transmit, to an integration enabler, a first discovery request for discovering available digital twin systems.

In operation 820, the metaverse system may receive, from the integration enabler, a list of digital twin systems registered in the integration enabler in response to the first discovery request.

In operation 830, the metaverse system may transmit, to the integration enabler, a second discovery request for discovering digital twin models managed by a selected digital twin system among the list of digital twin systems.

In operation 840, the metaverse system may receive, from the integration enabler, a list of digital twin models managed by the selected digital twin system in response to the second discovery request.

In operation 850, the metaverse system may select one of the digital twin models in the list according to a user selection and provide a metaverse service to a user.

The metaverse system may transmit a virtual model generated in the metaverse for the selected digital twin model to a digital twin system. The metaverse system may reflect changes in a physical world under the control of the digital twin system by interworking with the integration enabler when a digital twin is modified in the metaverse.

The descriptions provided above with reference to FIGS. 1 through 7 are also applicable to the operations illustrated in FIG. 8, and detailed description thereof will be omitted.

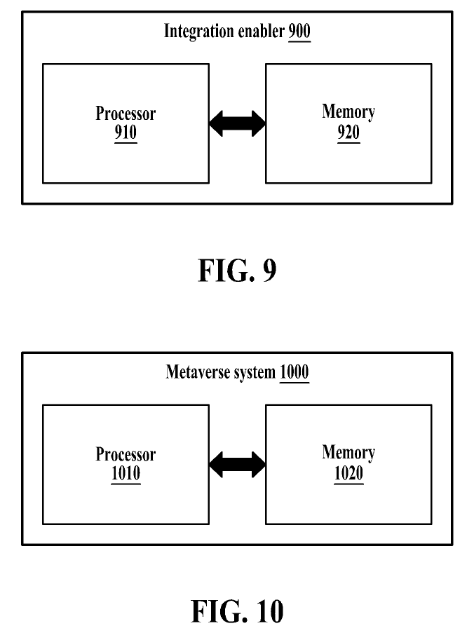

FIG. 9 is a block diagram illustrating an integration enabler according to an embodiment.

Referring to FIG. 9, the integration enabler 900 may include a processor 910. The processor 910 may include at least one processor. In addition, the integration enabler 900 may further include a memory 920.

The memory 920 may store instructions (e.g., a program) executable by the processor 910. For example, the instructions may include instructions to perform operations of the processor 910 and/or operations of respective components of the processor 910.

The processor 910 may be a device for executing instructions (e.g., programs or commands) or for controlling the integration enabler 900 and may include various processors such as a central processing unit (CPU) or a graphics processing unit (GPU). The processor 910 may receive, from a metaverse system, a first discovery request for discovering available digital twin systems. In response to the first discovery request, the processor 910 may provide, to the metaverse system, a list of digital twin systems registered in the integration enabler 900. The processor 910 may receive, from the metaverse system, a second discovery request for discovering digital twin models managed by a selected digital twin system among the list of digital twin systems. In response to the second discovery request, the processor 910 may provide, to the metaverse system, a list of digital twin models managed by the selected digital twin system.

The processor 910 may receive an access request including access information about a selected digital twin model among a list of digital twin models from a metaverse system. Upon the access request, the processor 910 may request the selected digital twin model from a digital twin system, and in response to receiving the selected digital twin model from the digital twin system, may transmit the selected digital twin model to the metaverse system. The processor 910 may determine whether the selected digital twin system and the metaverse system have different formats, and in response to determining that they have different formats, may convert the format of the selected digital twin model before transmitting it to the metaverse system. The processor 910 may perform synchronization between a virtual object of the metaverse provided by the metaverse system and a corresponding physical object managed by the digital twin system. In response to receiving a registration request for system information from the digital twin system, the processor 910 may register the system information, and in response to receiving a registration request for metadata of a digital twin model from the digital twin system, may register that metadata of the digital twin is managed in the digital twin system. In response to the first discovery request, the processor 910 may provide, to the metaverse system, at least one of supported model types, communication protocols, update mechanisms, application domains, regions, real-time functions, and ownership for each digital twin system. The processor 910 may determine a digital twin model that is no longer maintained, valid, or publicly accessible among digital twin models managed by the selected digital twin system and may deregister metadata of the determined digital twin model. The processor 910 may determine a digital twin system that is no longer active or no longer participating in digital twin integration with the metaverse among registered digital twin systems and may deregister the determined digital twin system.

In addition, the integration enabler 900 may perform the above-described operations.

FIG. 10 is a block diagram illustrating a metaverse system according to an embodiment.

Referring to FIG. 10, a metaverse system 1000 may include a processor 1010. The processor 1010 may include at least one processor. In addition, the metaverse system 1000 may further include a memory 1020.

The memory 1020 may store instructions (e.g., a program) executable by the processor 1010. For example, the instructions may include instructions to perform operations of the processor 1010 and/or operations of respective components of the processor 1010.

The processor 1010 may be a device for executing instructions (e.g., programs or commands) or for controlling the metaverse system 1000 and may include various processors such as a CPU or a GPU. The processor 1010 may transmit, to an integration enabler, a first discovery request for discovering available digital twin systems. In response to the first discovery request, the processor 1010 may receive, from the integration enabler, a list of digital twin systems registered in the integration enabler. The processor 1010 may transmit, to the integration enabler, a second discovery request for discovering digital twin models managed by a selected digital twin system among the list of digital twin systems. In response to the second discovery request, the processor 1010 may receive, from the integration enabler, a list of digital twin models managed by the selected digital twin system. The processor 1010 may select one of digital twin models in the list according to a user selection and provide a metaverse service to a user.

The processor 1010 may transmit a virtual model generated in the metaverse for the selected digital twin model to a digital twin system. The processor 1010 may reflect changes in a physical world under the control of the digital twin system by interworking with the integration enabler when a digital twin is modified in the metaverse.

In addition, the metaverse system 1000 may perform the above-described operations.

The examples described herein may be implemented by using a hardware component, a software component, and/or a combination thereof. A processing device may be implemented using one or more general-purpose or special-purpose computers, such as, for example, a processor, a controller and an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing unit is used as singular; however, one skilled in the art will appreciate that a processing unit may include a plurality of processing elements and a plurality of types of processing elements. For example, the processing device may include a plurality of processors, or a single processor and a single controller. In addition, different processing configurations are possible, such as parallel processors.

Software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random-access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

As described above, although the examples have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Therefore, other implementations, other examples, and equivalents to the claims are also within the scope of the following claims.

What is claimed is:

1. A method of operating an integration enabler, the method comprising:
receiving, from a metaverse system, a first discovery request for discovering an available digital twin system;
providing, in response to the first discovery request, a list of digital twin systems registered in the integration enabler to the metaverse system;
receiving, from the metaverse system, a second discovery request for discovering digital twin models managed by a selected digital twin system among the list of digital twin systems; and
providing, in response to the second discovery request, a list of digital twin models managed by the selected digital twin system to the metaverse system.

2. The method of claim 1, further comprising:
receiving, from the metaverse system, an access request including access information on a selected digital twin model among the list of digital twin models;
requesting, in response to the access request, the selected digital twin model from a digital twin system; and
transmitting, in response to receiving the selected digital twin model from the digital twin system, the selected digital twin model to the metaverse system.

3. The method of claim 2, wherein the transmitting of the selected digital twin model comprises:
determining whether a format of the selected digital twin system is different from a format of the metaverse system; and
in response to determining that the formats are different, transforming the format of the selected digital twin model and transmitting the transformed digital twin model to the metaverse system.

4. The method of claim 2, further comprising:
performing synchronization between a virtual object provided by the metaverse system and a corresponding physical object managed by the digital twin system.

5. The method of claim 1, further comprising:
registering, in response to receiving a registration request for system information from a digital twin system, the system information; and
registering, in response to receiving a registration request for metadata of a digital twin model from the digital twin system, that the metadata of the digital twin model is managed in the digital twin system.

6. The method of claim 1, wherein the providing of the list of the digital twin systems to the metaverse system comprises:
providing, in response to the first discovery request, at least one of supported model types, communication protocols, update mechanisms, an application domain, a region, a real-time function, and ownership for each of the digital twin systems to the metaverse system.

7. The method of claim 1, further comprising:
determining a digital twin model that is no longer maintained, valid, or publicly accessible among the digital twin models managed by the selected digital twin system; and
deregistering metadata of the determined digital twin model.

8. The method of claim 1, further comprising:
determining a digital twin system that is no longer activated or no longer participating in digital twin integration with a metaverse among registered digital twin systems; and
deregistering the determined digital twin system.

9. A method of operating a metaverse system, the method comprising:
transmitting, to an integration enabler, a first discovery request for discovering an available digital twin system;
receiving, in response to the first discovery request, a list of digital twin systems registered in the integration enabler from the integration enabler;
transmitting a second discovery request for discovering digital twin models managed by a selected digital twin system among the list of digital twin systems to the integration enabler;
receiving, in response to the second discovery request, a list of digital twin models managed by the selected digital twin system from the integration enabler; and
selecting, upon a user selection, one of the digital twin models in the list to provide a metaverse to the user.

10. The method of claim 9, further comprising:
transmitting, to a digital twin system, a virtual model generated in the metaverse for a selected digital twin model.

11. The method of claim 9, further comprising:
when a digital twin is modified in the metaverse, under control of the digital twin system and in association with the integration enabler, reflecting changes in a physical world.

12. A non-transitory computer-readable storage medium storing instructions that, when executed by a processor, cause the processor to perform the method of claim 1.

13. An integration enabler comprising:
a processor; and
a memory storing instructions,
wherein the instructions, when executed by the processor, cause the integration enabler to:
receive, from a metaverse system, a first discovery request for discovering an available digital twin system;
provide, in response to the first discovery request, a list of digital twin systems registered in the integration enabler to the metaverse system;
receive, from the metaverse system, a second discovery request for discovering digital twin models managed by a selected digital twin system among the list of digital twin systems; and
provide, in response to the second discovery request, a list of digital twin models managed by the selected digital twin system to the metaverse system.

14. The integration enabler of claim 13, wherein the instructions, when executed by the processor, cause the integration enabler to:
receive, from the metaverse system, an access request including access information on a selected digital twin model among the list of digital twin models;
request, in response to the access request, the selected digital twin model from a digital twin system; and
transmit, in response to receiving the selected digital twin model from the digital twin system, the selected digital twin model to the metaverse system.

15. The integration enabler of claim 14, wherein the instructions, when executed by the processor, cause the integration enabler to:
determine whether a format of the selected digital twin system is different from a format of the metaverse system; and
in response to determining that the formats are different, transform the format of the selected digital twin model and transmit the transformed digital twin model to the metaverse system.

16. The integration enabler of claim 14, wherein the instructions, when executed by the processor, cause the integration enabler to:
perform synchronization between a virtual object provided by the metaverse system and a corresponding physical object managed by the digital twin system.

17. The integration enabler of claim 13, wherein the instructions, when executed by the processor, cause the integration enabler to:
register, in response to receiving a registration request for system information from a digital twin system, the system information; and
register, in response to receiving a registration request for metadata of a digital twin model from the digital twin system, that the metadata of the digital twin model is managed in the digital twin system.

18. The integration enabler of claim 13, wherein the instructions, when executed by the processor, cause the integration enabler to:
provide, in response to the first discovery request, at least one of supported model types, communication protocols, update mechanisms, an application domain, a region, a real-time function, and ownership for each of the digital twin systems to the metaverse system.

19. The integration enabler of claim 13, wherein the instructions, when executed by the processor, cause the integration enabler to:
determine a digital twin model that is no longer maintained, valid, or publicly accessible among the digital twin models managed by the selected digital twin system; and
deregister metadata of the determined digital twin model.

20. The integration enabler of claim 13, wherein the instructions, when executed by the processor, cause the integration enabler to:
determine a digital twin system that is no longer activated or no longer participating in digital twin integration with a metaverse among registered digital twin systems; and
deregister the determined digital twin system.
